(19) United States
(12) Patent Application Publication
(10) Pub. No.: US 2007/0028852 A1
(43) Pub. Date: Feb. 8, 2007

(54) Pet toy and cover therefor

(76) Inventor: Tracey Ciciora, Aurora, IL (US)

Correspondence Address: PERRY HOFFMAN & ASSOCIATES P.C., PO BOX 1649, DEERFIELD, IL, 60015, US

(21) Appl. No.: 11/497,846

(22) Filed: Aug. 2, 2006

Related U.S. Application Data
(60) Provisional application No. 60/706,082, filed on Aug. 5, 2005.

(51) Int. Cl. A01K 29/00

(52) U.S. Cl. 119/709

(57) ABSTRACT

A one piece sheet material for packaging cover to be used as a dust jacket for wrapping around a pet toy that resembles a book. The sheet material is an overall wrapping with bend lines corresponding to the dimensions of the pet toy, so that the sheet material folds around the circumference of the pet toy. A fold-over flap on the sheet material is on the backside of the pet toy, and another portion of the sheet material wraps around the front edge and tucks behind the fold-over flap, creating a concept of a pet toy book. The utility and process of the dust jacket in combination with the pet toy protect and substantially enclose the pet toy and create the distinguishing novelty of books for pets with titles and pet authors.

### CROSS-REFERENCE TO RELATED APPLICATION

This application claims priority pursuant to 35 U.S.C. 119(e) to U.S. Provisional Application No. 60/706,082 filed on Aug. 5, 2005 which is incorporated herein by reference in its entirety.

### FIELD OF THE INVENTION

The present invention relates generally to pet toys. More particularly, the present invention relates to the design and usage thereof for a pet toy concept including packaging. The design of the pet toy itself in overall shape comprises a book-shaped toy.

### BACKGROUND OF THE INVENTION

Pet ownership is extremely common today, and it has been for some time. Animals that spend large amounts of time indoors need entertainment and exercise to stay happy and healthy. Accordingly, many pet toys are known that provide pets with the stimulating physical activity they require. However, few of these toys are designed to provide benefits specifically to the pet owner.

Because a typical pet toy is used between an owner and a pet, encouraging interaction between them, the toy should be enjoyable to the owner, so that the owner may benefit from the toy just as the pet does. Most pet toys that are known are designed solely with the pet in mind, offering features aimed at keeping the pet interested in the toys for as long as possible. Such aspects include, for example, bright colors, waving appendages, or emanating noises. However, given the opportunity for bonding between a pet and owner, it would be advantageous for the pet toy to offer some appeal to the owner as well, so that the owner also remains interested in the toy.

A toy that is aesthetically pleasing to an owner would accomplish the preceding goal. Moreover, a set of such toys, each element meant to complement the others, could offer a pleasing decor in a household. Also, printed information provided with the toy, humorous or informative, could enhance a pet owner's experience with the pet toy. Accordingly, there are a number of ways to package and market a pet toy that would increase the appeal to the owner.

### SUMMARY OF THE INVENTION

A significant aspect of this invention is to provide a new higher-end quality pet toy that has particular appeal to pet owners that spend more quality time with their pets as well as consider them a member of the family.

Another and more specific aspect of this invention is to provide a pet toy that has more appeal than a typical pet fetch toy in that the packaging itself becomes a product for the pet owner as printed information will guide the pet owner to informational websites and organizations relating to various pet and human areas of interest.

Another aspect of this invention is to provide a pet toy that can be put back into its packaging and used as decor. The pet toy book used in tandem with the book jacket, which wraps completely around the pet book toy, is of distinct novelty as the concept requires both elements to capture the objective. The pet toy book can also have many pet-relatable spine designs including the pictured bone-shaped spine design.

Still another aspect of this invention is to use both elements of the pet toy and packaging to create an entire library of book titles including authors for pet and owner whereby both pet toy book and packaging will both be embellished with title and author with various pet toy body designs as well as specific-to-title book jackets. Additionally, these titles can later be explored and related to in companion products of actual stories created from titled pet toy books.

Briefly summarized, the present invention relates to a one piece sheet material for packaging to be used as a dust jacket for wrapping around a pet toy that resembles a book. The sheet material is an overall wrapping with bend lines corresponding to the dimensions of the pet toy, so that the sheet material folds around the circumference of the pet toy. A fold-over flap on the sheet material is on the backside of the pet toy, and the opposing side of the sheet material wraps around the front edge of the pet toy and tucks behind the fold-over flap, creating a concept of a pet toy book.

### BRIEF DESCRIPTION OF THE DRAWINGS

For the purpose of facilitating an understanding of the inventions, the accompanying drawings and description illustrate a preferred embodiment thereof, from which the inventions, structure, construction and operation, and many related advantages may be readily understood and appreciated.

FIG. 1 shows a packaging formed in accordance with one embodiment of the present invention to resemble a book jacket;

FIGS. 2 and 3 illustrate the packaging of FIG. 1 with the pet toy embodiment of the present invention, wherein the toy book and wrap around jacket cooperate advantageously to provide a book for dogs concept in accordance with the invention;

FIG. 4 shows a pet toy configured as a book;

FIG. 5 shows a pet toy configured as a book having a bone design for the spine area with indicia thereon;

FIG. 6 shows a pet toy configured as a stack of books;

FIG. 7 illustrates a cross-sectional view of the pet toy configured as a book within which a filler material such as a polyester fill is stuffed;

FIGS. 8A-E illustrates spine, front cover, page, bottom and top views of a pet toy configured as a book;

FIG. 9 illustrates an alternative embodiment of the invention wherein the height dimension of the cover does not fully extend to the top and bottom of the book;

FIG. 10 shows another view of the alternative embodiment of FIG. 9; and

FIG. 11 shows the packaging formed in accordance with the embodiment of FIG. 9 to resemble a book jacket.

### DESCRIPTION OF THE PREFERRED EMBODIMENTS

The following description is provided to enable those skilled in the art to make and use the described embodiments set forth in the best modes contemplated for carrying out the invention. Various modifications, however, will remain readily apparent to those skilled in the art. Any and all such modifications, equivalents, and alternatives are intended to fall within the spirit and scope of the present invention.

A present preferred embodiment is implemented as described herein, the design of which is covered in applicant's co-pending U.S. Design patent application Ser. No. ______, (Attorney Docket No. 28-001.2) filed on even date, the entire disclosure of which is hereby incorporated herein by reference.

Embodiments of the present invention relate to pet toys and more particularly to a novel idea of a toy book and package that work together so as to create a distinguishing, altogether new and novel pet product and yet familiar and relatable to pet owners from a literary and humorous appreciation.

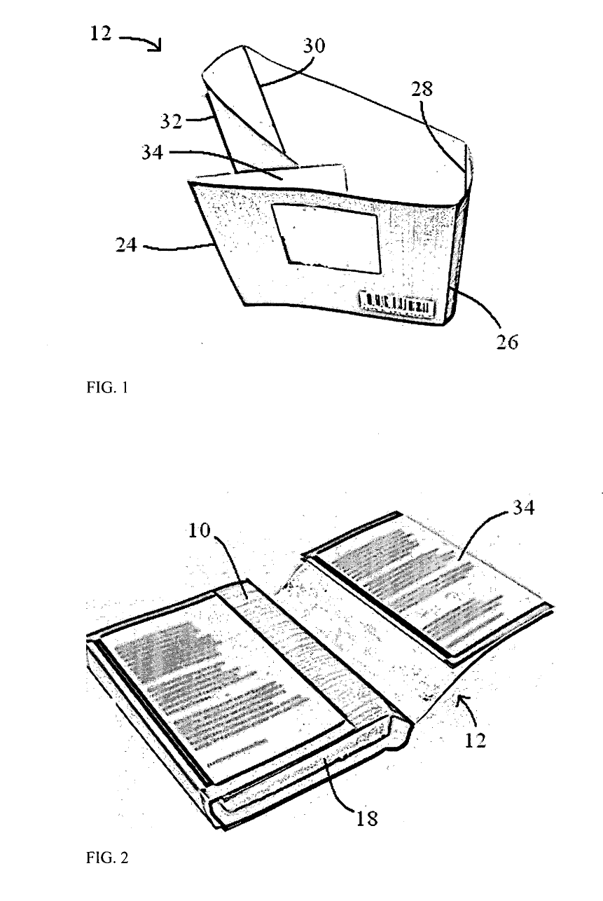

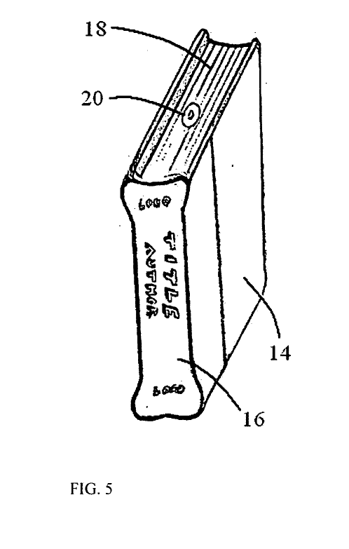

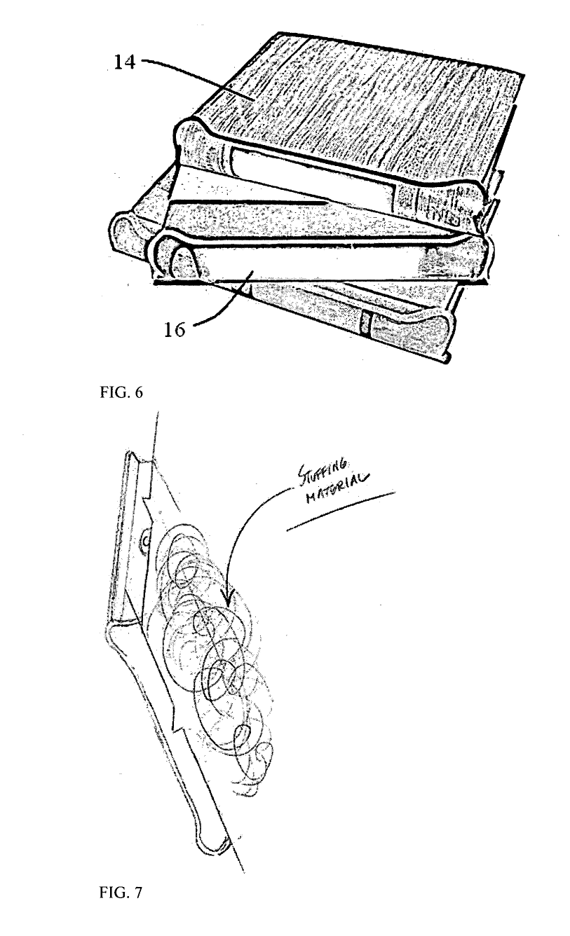

Referring now to the figures, FIGS. 1-8 illustrate one embodiment of the invention comprising a pet toy 10 and a sheet material packaging cover 12. Referring to FIG. 5 and in accordance with the concept of the present embodiment, the pet toy 10 is made of an enclosed box having an exterior shaped to resemble a book, including the appearance of a hardcover 14 with a spine 16 and pages 18 between the front and back portions of the hardcover. FIGS. 4 and 5 illustrate the pet toy in the present described embodiment as a book.

The pet toy 10 to which the present embodiment applies is formed essentially of any flexible or elastomer material that cures to a body having the desired flexibility. Since its use is for pet toys, the material should also be nontoxic. For example, the toy can be made from materials such as rubber-type processes of latex, PVC, vinyl, to name a few. Alternatively, the toy can be made from plush fabric materials. The inside of the toy may contain a squeak mechanism, as is common in many pet toys. FIG. 5 shows a small opening 20 in the page portion 18 of the of the book design, allowing air to enter and exit. This facilitates a squeak sound when the book is compressed and decompressed by pressure activation. As illustrated in FIG. 7, the present embodiment has a filler material 22, such as a polyester fill. Alternatively, the toy may be filled with another material or be hollow altogether.

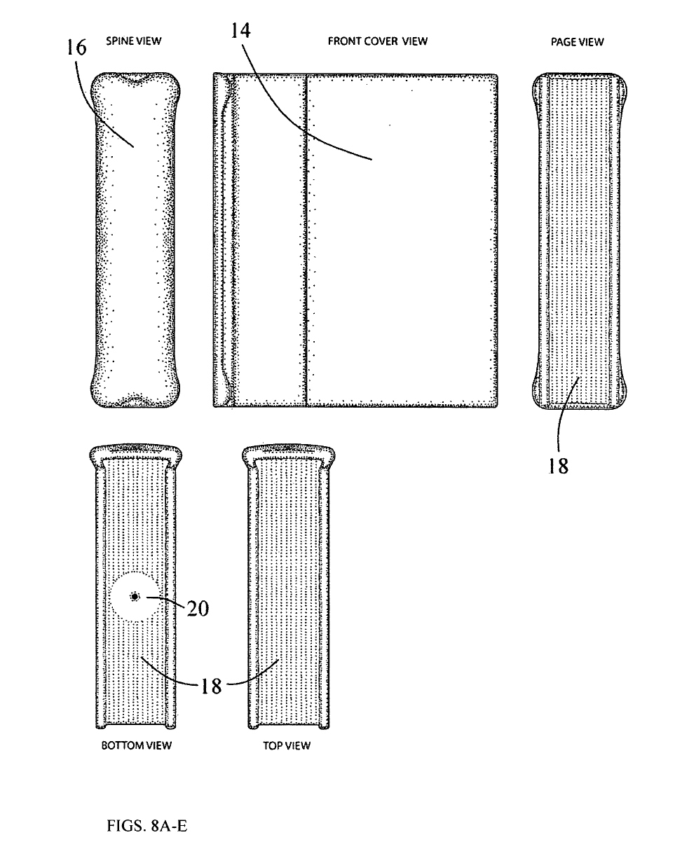

As shown in FIG. 5 and FIG. 8A, the overall design of the pet toy used in the present embodiment is provided with a bone design for the spine area 16. A rounded extension overhanging each corner of the spine makes the spine appear as a bone, reinforcing the theme of the present embodiment. Although the bone design would apply particularly well to dogs, the pet toy can have unlimited ornamental design variations corresponding to any number of different types of pets. The book itself can be molded with ornamental elements in unlimited sizes and shapes. As illustrated in FIG. 5, the page area 18 of the pet toy is slotted with grooves running along its length, creating the appearance of separate pages as in an actual book.

FIG. 1 illustrates the packaging cover 12 to wrap around the pet toy 10. The cover is a one piece sheet material that is designed to resemble a book jacket. However, unlike a typical book jacket, the cover 12 wraps fully around the circumference of the book, rather than tucking into the front and back covers.

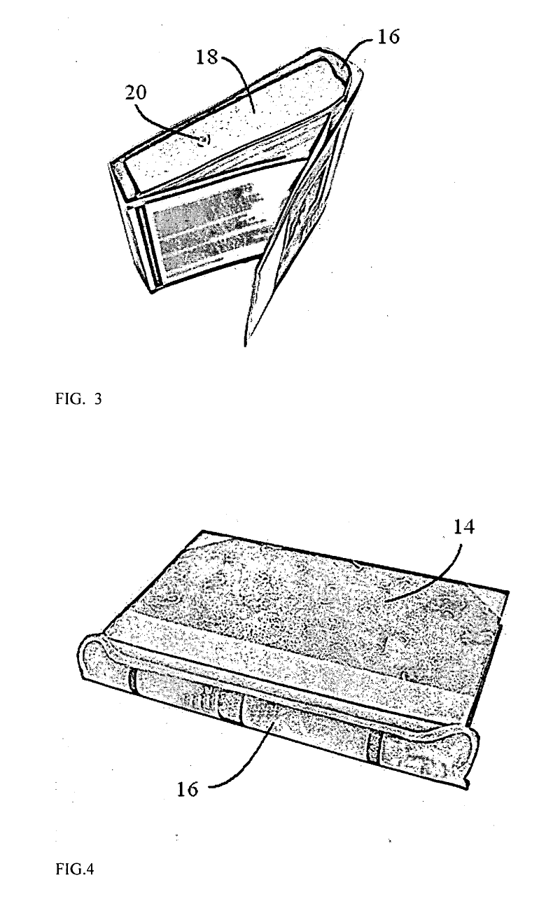

The sheet material, which may extend substantially from top to bottom of the pet toy 10, is an overall wrapping that has bend lines 24, 26, 28, 30, 32 which may be soft scored thereon corresponding to the dimensions of the pet toy 10 so that the sheet material folds around the circumference of the pet toy 10, as illustrated in FIGS. 2 and 3. Referring to FIG. 1, the first scored bend line 24 creates a fold-over flap 34 along the backside of the cover. The second bend line 26 and third bend line 28 occur on corresponding sides of the spine 16, so as to wrap the cover 12 around the spine 16 and along the front of the book. Similarly, the fourth bend line 30 and fifth bend line 32 wrap the cover 12 around the pages 18 and back along the backside of the book. The remaining portion of the cover 12 that continues past the fifth bend line 32 tucks behind the fold-over flap 34 created by the first bend line 24. These two surfaces of the cover are held in attachment by Velcro™, which holds the cover 12 in place on the book. Alternatively, the cover 12 could be secured by another fastening means, such as a hook and loop fastener, clip fastener, resealable adhesive, magnetic fastener, button, clasp, or other.

As contemplated, the cover 12 may be made out of sheet, canvas-type or plush material, ballistic material or other robust toy materials, or eatable materials such as formed rawhide. Functional aspects of the dust jacket flaps are directed to specific considerations concerning folding and how they are utilized as described herein.

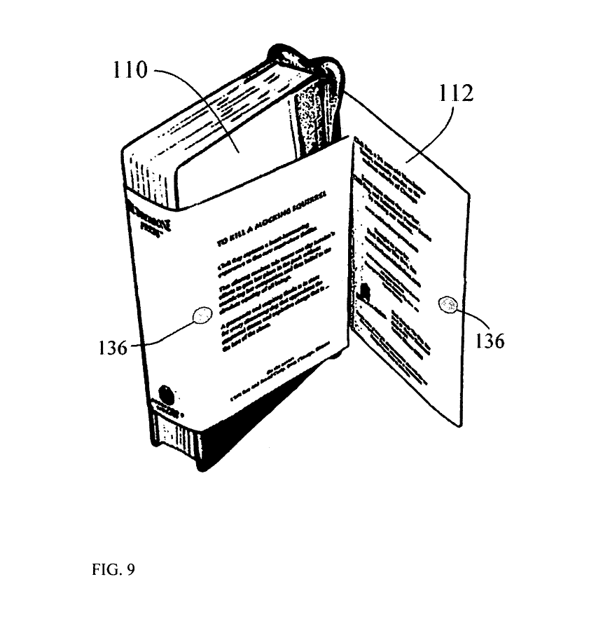

FIGS. 9-11 illustrate an alternative embodiment of the invention as a pet toy 110 and a sheet material packaging cover 112. While the pet toy book remains the same, the embodiment of FIGS. 9-11 differs from that of FIGS. 1-8 in the height dimension of the cover 112. Unlike a typical book jacket, the cover 112 does not fully extend to the top and bottom of the book 110. Rather, portions of the top and bottom of the book 110 remain visible, which is potentially advantageous in that it increases visibility of the aforementioned bone design of the spine as well as the overall book design of the pet toy. The cover 112 also wraps fully around the circumference of the book, rather than tucking into the front and back covers.

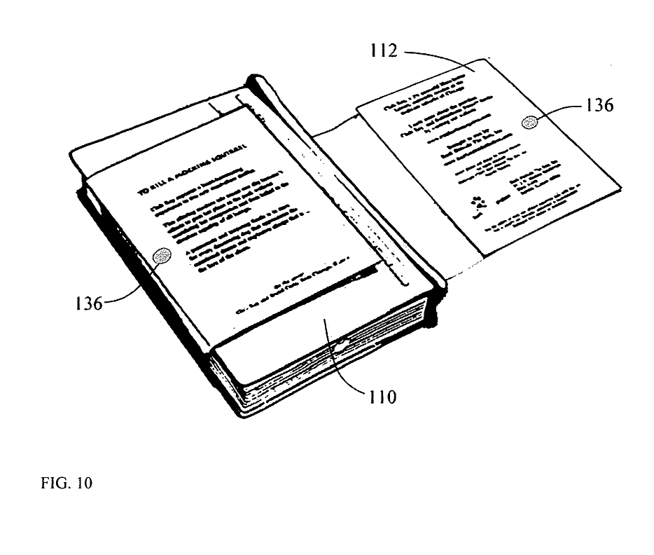

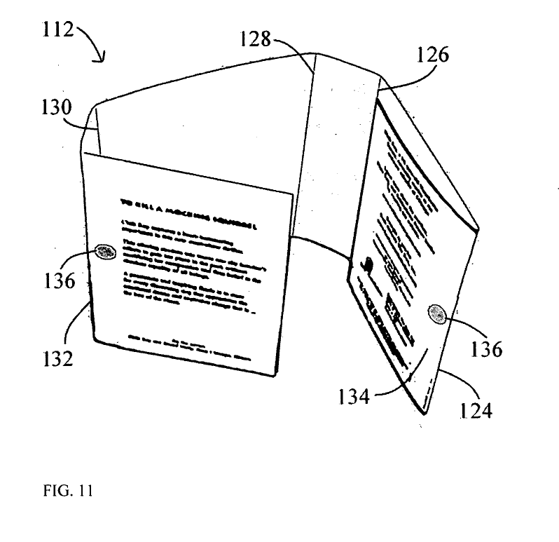

The sheet material is an overall wrapping that has bend lines 124, 126, 128, 130, 132 thereon corresponding to the dimensions of the pet toy 110, so that the sheet material folds around the circumference of the pet toy 110, as illustrated in FIGS. 9 and 10. Referring to FIG. 11, the first scored bend line 124 creates a fold-over flap 134 along the backside of the cover. The second bend line 126 and third bend line occur on corresponding sides of the spine, so as to wrap the cover 112 around the spine and along the front of the book. Similarly, the fourth bend line 130 and fifth bend line 132 wrap the cover 112 around the pages and back along the backside of the book. The remaining portion of the cover 112 that continues past the fifth bend line 132 tucks behind the fold-over flap 134 created by the first bend line 124. These two surfaces of the cover are held in attachment by a piece of Velcro™ 136, which holds the cover 112 in place on the book. Alternatively, the cover 112 could be secured by another fastening means, such as a hook and loop fastener, clip fastener, resealable adhesive, magnetic fastener, button, clasp, or other.

As contemplated, the cover 112 may be made out of plush, or a canvas-type material, ballistic material or other indestructible toy materials. Functional aspects of the dust jacket flaps are directed to specific considerations concerning folding and how they are utilized as described herein.

A new and novel type of book jacket packaging is utilized to an advantageous end whereas the toy book and wrap around jacket would work together to complete a new concept of, e.g. books for dogs. In using the new type of book jacket for a dog toy, as does the present embodiment, there would be a play on real hardcover reading books with dust covers. The dog toy of a book with a dust jacket that wraps completely around the book is a new and novel idea because, unlike traditional dust jackets, the described packaging of the new dust jacket completely wraps around the toy book as an enclosure, and not merely as a cover, thus also serving as product packaging. Whereas traditional dust jackets flap inside the covers exposing the area for the page edges, dust jacket of the described embodiments have an extra depth of paper and folds to completely cover the entire circumference of the toy book (pet toy). With folds completely covering the entire product, the end product allows for marketing of pet toys much as that of books. The book is also novel in that it may be provided as a squeeze toy and does not open up as a traditional book does with pages. The combination of the toy book and the full wrap-around dust jacket with the feature of the extra width of jacket is unique and unlike any dog toy out in the market.

The cover is also advantageous in its ability to create a distinguishing novelty of books for pets with titles and pet authors. The described embodiments contemplate products in a line of squeaky rubber “book” toys with an “author,” e.g., Chili Ray, and may include various other indicia. This product may be trademarked, e.g., with RUBBERBONE PRESS™ or the like having distinguishing logos, etc. The toy books are packaged using somewhat traditional book jackets for a play on real hardcover books with dust jackets. The dust jacket flaps may be utilized as well to direct customers to company websites or for other information. The website can serve in a variety of ways where dog lovers can gain information on the products and company, be directed to other sources of interest, find retail outlets for merchandise or order promotional products. Retailers may place wholesale orders online, etc. Customers may be independent book stores, high-end dog boutiques, novelty boutiques, select catalogs, or web stores which resell the products to consumers.

From the foregoing, it can be seen that there has been provided features for a novel pet toy concept. While a particular embodiment of the present invention has been shown and described, it will be obvious to those skilled in the art that changes and modifications may be made without departing from the invention in its broader aspects. Therefore, the aim is to cover all such changes and modifications as fall within the true spirit and scope of the invention. The matter set forth in the foregoing description and accompanying drawings is offered by way of illustration only and not as a limitation. The actual scope of the invention is intended to be defined by subsequent claims when viewed in their proper perspective based on the prior art.

What is claimed is:

1. A packaging material for use with a pet toy, said pet toy having a length, width, thickness, and circumference, said packaging material comprising:
a one-piece sheet material resembling a book dust jacket, said sheet material having a width greater than the circumference of the pet toy; and
an overall wrapping with bend lines occurring at the width and thickness dimensions of the pet toy, so that the sheet material is capable of wrapping around the pet toy and appearing as a dust jacket therefor, creating the concept of the pet toy as a book.

2. The packaging material as set forth in claim 1, wherein said bend lines create a fold-over flap on the backside of the pet toy, and a portion of the sheet material wraps over the thickness of the front edge of the pet toy and tucks behind the fold-over flap.

3. The packaging material as set forth in claim 1, wherein the sheet material includes information to create the novelty of books for pets with titles or pet authors.

4. The packaging material as set forth in claim 1, wherein the length of said sheet material is similar to the length of the book pet toy.

5. The packaging material as set forth in claim 1, wherein the length of said sheet material is shorter than the length of the book pet toy.

6. The packaging material as set forth in claim 1, comprising a pet toy in the shape of and resembling a book.

7. The packaging material as set forth in claim 6, wherein the pet toy is formed by a molded rubber material which encases a supply of fill material.

8. The packaging material as set forth in claim 7, wherein a sound-producing device is provided for producing sound with the molded rubber material.

9. An apparatus for entertaining a pet, comprising:
a pet toy resembling a book, said pet toy having a length, width, thickness, and circumference; and
a packaging material covering the pet toy, the packaging material comprising a one-piece sheet material resembling a book dust jacket and an overall wrapping with bend lines occurring at the width and thickness dimensions of the pet toy, so that the sheet material is capable of wrapping around the pet toy and appearing as a dust jacket therefor, wherein the sheet material includes information to create the novelty of books for pets with titles or pet authors, creating the concept of the pet toy as a book.

10. The apparatus as set forth in claim 9, wherein the length of said sheet material is similar to the length of the book.

11. The apparatus as set forth in claim 9, wherein the length of said sheet material is shorter than the length of the book.

12. The apparatus as set forth in claim 9, wherein said sheet material comprises an eatable material such as formed rawhide.
